(19) United States
(12) Patent Application Publication
(10) Pub. No.: US 2023/0134381 A1
(43) Pub. Date: May 4, 2023

(54) MANAGEMENT DEVICE AND MANAGEMENT METHOD

(71) Applicant: NIPPON TELEGRAPH AND TELEPHONE CORPORATION, Tokyo (JP)

(72) Inventors: Ayako IWAKI, Musashino-shi, Tokyo (JP); Shinichi YOSHIHARA, Musashino-shi, Tokyo (JP)

(73) Assignee: NIPPON TELEGRAPH AND TELEPHONE CORPORATION, Tokyo (JP)

(21) Appl. No.: 17/912,906

(22) PCT Filed: Mar. 24, 2020
(86) PCT No.: PCT/JP2020/012877

§ 371 Date: Sep. 20, 2022

(51) Int. Cl. H04L 45/247; H04L 45/02

(52) U.S. Cl. CPC H04L 45/247; H04L 45/02

(57) ABSTRACT

An object of the present invention is to provide a management device and a management method with which it is possible, in a multilayer integrated NW, to reflect a tendency to failure in a transmission layer in maintenance of an NW constituting an upper layer.

A management device according to the present invention, by using an index for evaluating the signal quality of the transmission layer as a trigger for performing a preventive maintenance switch in the NW of the upper layer and determining, in an integrated fashion, the effect of performing route switches on the respective layers on a functional requirement such as delay, realizes preventive maintenance on an accommodated line through correlation between communication layers in a manner that more closely satisfies the functional requirements of the NW.

### TECHNICAL FIELD

The present disclosure relates to a management device and a management method for detecting a failure or a predictor of a failure in a network (NW) system constituted by a plurality of communication layers and avoiding the effect thereof on signal communication.

### BACKGROUND ART

Multilayer integrated NW operating systems (OpS) are being put to practical use, and are used with the aim of performing network optimization across communication layers by, for example, reflecting the characteristics (the transmission delay and so on) of a transmission layer in optimization of the path design of an upper layer (see NPL 1, for example).

### CITATION LIST

### Non Patent Literature

[NPL 1] Takuya TOJO, Shingo OKADA, Yoshiyuki HIRATA, Seisho YASUKAWA, NTT Technical Review, Vol. 30, No. 5, pp. 47-50, 2018

### SUMMARY OF THE INVENTION

### Technical Problem

With the multilayer integrated NW OpS disclosed in NPL 1, it is only possible to take countermeasures such as isolation and redundant switching during line setting and when a failure occurs. Therefore, even when a line with a strict requirement regarding the signal interruption time is accommodated in the upper layer, during an actual operation, route switching cannot be performed until a signal interruption occurs on the transmission layer or the layer of the line, making it difficult to avoid a signal interruption on the line. In other words, a problem of the multilayer integrated NW OpS disclosed in NPL 1 is that it is difficult to reflect a tendency to failure in the transmission layer in maintenance of the NW constituting the upper layer.

Hence, in order to solve the problem described above, an object of the present invention is to provide a management device and a management method with which it is possible, in a multilayer integrated NW, to reflect a tendency to failure in a transmission layer in maintenance of an NW constituting an upper layer.

### Means for Solving the Problem

To achieve the object described above, in a management device and a management method according to the present invention, the states of routes set in a transmission layer are monitored, and when a route on which the monitored value has reached or is close to a reference value exists, either the route is switched to a backup route or a route corresponding to this route on the upper layer is switched to a backup route.

More specifically, a management device according to the present invention is a management device for managing a network that includes a transmission layer constituted by an optical transmission network and an upper layer that differs from the transmission layer, the management device including:

a database storing topology correspondence information between the transmission layer and the upper layer;

a monitoring unit that monitors routes set in the transmission layer and extracts, from among the routes, a preventive maintenance subject route that satisfies a predetermined requirement;

a selection unit that refers to the topology correspondence information in order to calculate a function of the upper layer in each of a case where a backup route is set in the transmission layer on the basis of a route through the upper layer that corresponds to the preventive maintenance subject route and a case where a backup route is set in the upper layer on the basis of the preventive maintenance subject route, and selects the superior function from among the two cases;

a device setting unit that sets the backup route of the case selected by the selection unit in the transmission layer or the upper layer; and

a configuration information updating unit that updates the database on the basis of the backup route set by the device setting unit.

Further, a management method according to the present invention is a management method for managing a network that includes a transmission layer constituted by an optical transmission network and an upper layer that differs from the transmission layer, the management method including:

extracting, from among routes set in the transmission layer, a preventive maintenance subject route that satisfies a predetermined requirement;

referring to topology correspondence information between the transmission layer and the upper layer in order to calculate a function of the upper layer in each of a case where a backup route is set in the transmission layer on the basis of a route through the upper layer that corresponds to the preventive maintenance subject route and a case where a backup route is set in the upper layer on the basis of the preventive maintenance subject route;

selecting the case in which the calculated function is superior;

setting the backup route of the selected case in the transmission layer or the upper layer; and

updating the database on the basis of the set backup route.

In the present management device and management method,

each route (transmission path) in the transmission layer is monitored, and an index, for example the pre-FEC Bit Error Rate (the bit error rate before error correction code is decoded; referred to hereafter as the pre-FEC BER), is collected. A transmission path (a preventive maintenance subject path) on which the pre-FEC BER has reached or is close to an FEC limit (a reference for determining a transmission path failure) is then detected. The transfer path (a preventive maintenance subject upper path) of the upper layer NW that is accommodated in the preventive maintenance subject path is also specified.

Then, in the present management device and management method,

either route control of the transmission layer alone or correlated route control of the transmission layer and the upper layer is selected in accordance with the NW requirements of the specified preventive maintenance subject upper path, whereupon a switch is performed to a transfer route that does not pass through the preventive maintenance subject path.

Hence, with the present management device and manufacturing method, a signal interruption on a line accommodated in a path of the transmission layer that is predicted to fail can be identified in advance, and communication can be continued on a path of the transmission layer or paths of the transmission layer and the upper layer that avoid this path. According to the present invention, therefore, it is possible to provide a management device and a management method with which, in a multilayer integrated NW, a tendency to failure in the transmission layer can be reflected in maintenance of the NW constituting an upper layer.

The management device and management method according to the present invention further include also monitoring routes set in the upper layer, and when a value monitored before and after setting of the backup route reaches a predetermined threshold, issuing an instruction to return the backup route to the state prior to setting. Hence, with the present management device and management method, it is possible to return to the original route when an abnormality of some type occurs following a switch to the backup route.

The management device and management method according to the present invention further include notifying the outside of the topology correspondence information between the transmission layer and the upper layer, which has been modified in accordance with the set backup route. Hence, with the present management device and management method, it is possible to share the result of route modification with an external operation system or the like, and in so doing, a communication network can be operated while ensuring consistency between all of the systems relating to network control.

Note that the inventions described above can be combined in any possible combinations.

### Effects of the Invention

According to the present invention, it is possible to provide a management device and a management method with which, in a multilayer integrated NW, a tendency to failure in the transmission layer can be reflected in maintenance of the NW constituting the upper layer.

### BRIEF DESCRIPTION OF DRAWINGS

FIG. 1 is a view illustrating a management device according to the present invention.

FIG. 2 is a view illustrating a case corresponding to a value that indicates the potential for failure.

FIG. 3 is a view illustrating a relationship between a transmission layer and an upper layer.

FIG. 4 is a view illustrating the relationship between the transmission layer and the upper layer.

FIG. 5 is a view illustrating an operation of the management device according to the present invention.

FIG. 6 is a view illustrating a function value calculated by a preventive maintenance operation selection unit of the management device according to the present invention.

FIG. 7 is a view illustrating a management device according to the present invention.

FIG. 8 is a view illustrating a management device according to the present invention.

### DESCRIPTION OF EMBODIMENTS

Embodiments of the present invention will be described with reference to the attached figures. The embodiments described below are examples of the present invention, and the present invention is not limited to the following embodiments. Note that constituent elements having identical symbols in the specification and the figures are assumed to denote identical elements.

### First Embodiment

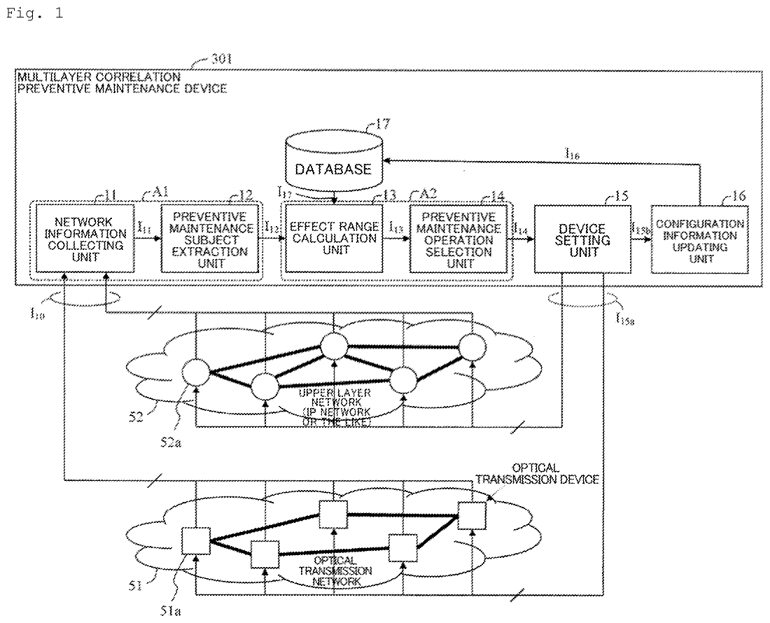

FIG. 1 is a view illustrating a management device 301 according to this embodiment. Note that in the specification and figures, the “management device” is also described as a “multilayer correlated preventive maintenance device”. The management device 301 is a management device for managing a network that includes a transmission layer 51 constituted by an optical transmission network and an upper layer 52 that differs from the transmission layer 51, the management device including:

a database 17 storing topology correspondence information I₁₇ between the transmission layer 51 and the upper layer 52;

a monitoring unit A1 that monitors routes set in the transmission layer 51 and extracts, from among the routes, a preventive maintenance subject route I₁₂ that satisfies a predetermined requirement;

a selection unit A2 that refers to the topology correspondence information I₁₇ in order to calculate a function of the upper layer 52 in each of a case where a backup route is set in the transmission layer 51 on the basis of a route through the upper layer 52 that corresponds to the preventive maintenance subject route I₁₂ and a case where a backup route is set in the upper layer 52 on the basis of the preventive maintenance subject route I₁₂, and selects the superior function from among the two cases;

a device setting unit 15 that sets the backup route of the case selected by the selection unit A2 in the transmission layer 51 or the upper layer 52; and

a configuration information updating unit 16 that updates the database 17 on the basis of the backup route set by the device setting unit 15.

Note that the monitoring unit A1 includes a network information collecting unit 11 and a preventive maintenance subject extraction unit 12, to be described below, and the selection unit A2 includes an effect range calculation unit 13 and a preventive maintenance operation selection unit 14, to be described below.

An operation of the network information collecting unit 11 will now be described. The network information collecting unit 11 collects monitoring information I₁₀, examples of which are indicated below, from optical transmission devices 51a of the optical transmission network serving as the transmission layer 51 and devices 52a (routers or the like) of an IP (Internet Protocol) network or the like serving as the upper layer 52.

Example 1 of Monitoring Information I₁₀ from Transmission Layer 51

Information about an index for evaluating the signal quality of each route (transmission path, wavelength path) formed in the transmission layer 51 is collected from the optical transmission devices 51a. The index is the Pre-FEC BER, for example.

Example 2 of Monitoring Information I₁₀ from Transmission Layer 51

Information that complements the Pre-FEC BER may also be collected in order to improve the determination of the preventive maintenance subject path by the preventive maintenance subject extraction unit 12. For example, this complementary information is constituted by the optical transmission power, the optical reception power, the central frequency of an optical signal, the signal-to-noise ratio of an electric signal (a wave detection signal), optical polarization mode dispersion, or polarization-dependent loss in the case of a digital coherent optical transmission system.

Example 3 of Monitoring Information I₁₀ from Transmission Layer 51 and Upper Layer 52

To confirm the normality of the operation when route modification is performed for the purpose of preventive maintenance,

either the information described above in example 1 and example 2 in the transmission path following the route modification is collected from the optical transmission devices 51a of the transmission layer 51, or

information (for example, the transfer bit rate, the frame discard rate, or the like) indicating state variation before and after modification in the route modification location is collected from the devices 52a of the upper layer 52.

In other words, the monitoring information I₁₀ from the transmission layer 51 is required to specify a failed route. The monitoring information I₁₀ from the upper layer 52, meanwhile, is supplementary information for confirming that route modification control has been performed normally. Attribute information from the transmission layer 51, such as the wavelength, the transmission band, and the transponder type, may also be included in the monitoring information I₁₀.

An operation of the preventive maintenance subject extraction unit 12 will now be described. The preventive maintenance subject extraction unit 12 receives monitoring information I₁₁ from the network information collecting unit 11. The monitoring information I₁₁ is the monitoring information I₁₀ collected by the network information collecting unit 11 from the transmission layer 51 and the upper layer 52. When the index used to evaluate the signal quality measured on each transmission path (wavelength path), the index being included in the monitoring information I₁₁, corresponds to a value indicating the potential for failure, the preventive maintenance subject extraction unit 12 determines the corresponding path to be a preventive maintenance subject. The preventive maintenance subject extraction unit 12 then outputs information I₁₂ indicating the preventive maintenance subject path.

Cases in which the index corresponds to a value indicating the potential for failure are as follows.

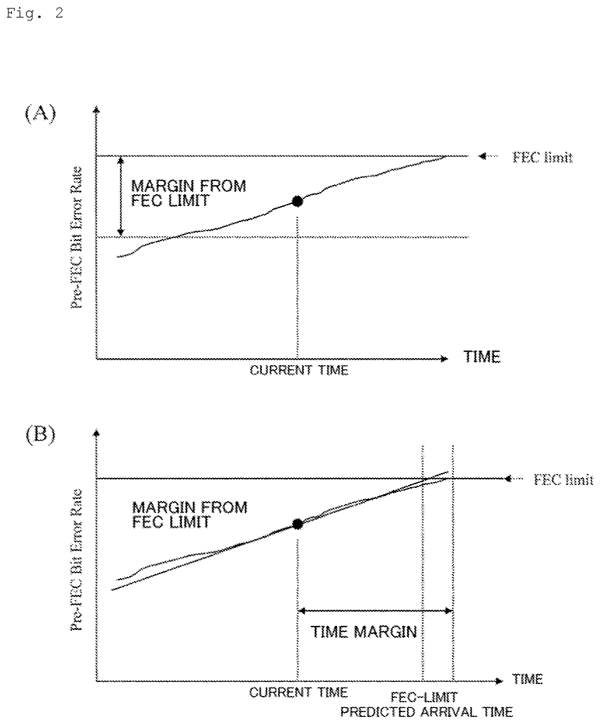

(Example 1) As shown in FIG. 2(A), this case occurs when the Pre-FEC BER is within a margin from the FEC limit.
(Example 2) As shown in FIG. 2(B), this case occurs when temporal variation in the Pre-FEC BER is interpolated by a curve or the like, a time (an FEC limit predicted arrival time) at which the interpolated line will exceed the FEC limit is detected, and the time is within a preset time margin.

Further, the preventive maintenance subject extraction unit 12 may use monitoring information I₁₁ other than that described above to estimate the state of the transmission line and the state of the transponder and isolate the cause of failure on the preventive maintenance subject path as either deterioration of the signal quality due to variation in the transmission line characteristics or deterioration of the transmission quality due to failure of the transponder.

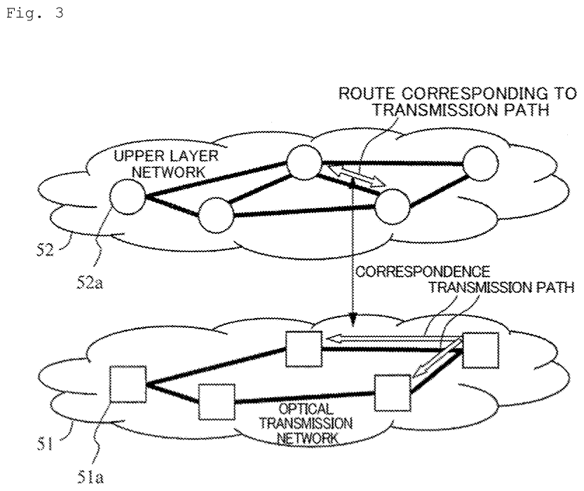

An operation of the database 17 will now be described. The database 17 manages network configuration information. The network configuration information is information indicating the transmission paths of the transmission layer 51 in which the routes connecting the devices 52a of the upper layer 52 are accommodated and the transmission lines through which these routes pass (see FIG. 3), this information being configured in a database format. A record may be added to the database 17 as an initial value at the time of a service order, or the database 17 may be constructed using setting information included in the monitoring information from the respective devices (51a, 52a) at fixed time intervals.

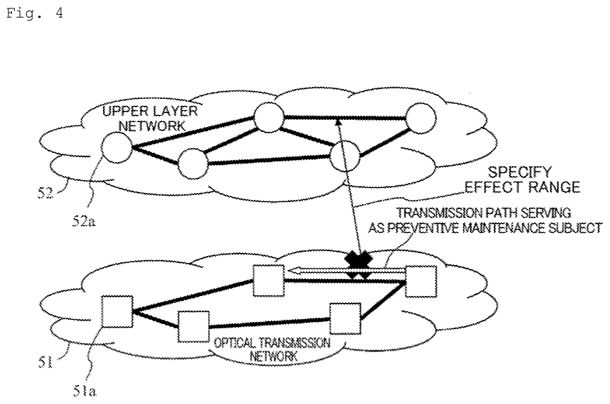

An operation of the effect range calculation unit 13 will now be described. FIG. 4 is a view illustrating the operation of the effect range calculation unit 13. The effect range calculation unit 13 uses network configuration information I₁₇ (the information indicating the transmission paths of the transmission layer 51 in which the routes connecting the devices 52a of the upper layer 52 are accommodated and the transmission lines through which these routes pass) acquired from the database 17 to specify, in relation to the preventive maintenance subject path in the information 112 transmitted thereto from the preventive maintenance subject extraction unit 12, the route through the upper layer 52 in which this path is accommodated. The effect range calculation unit 13 then outputs information I₁₃ indicating the preventive maintenance subject path and the corresponding route through the upper layer network.

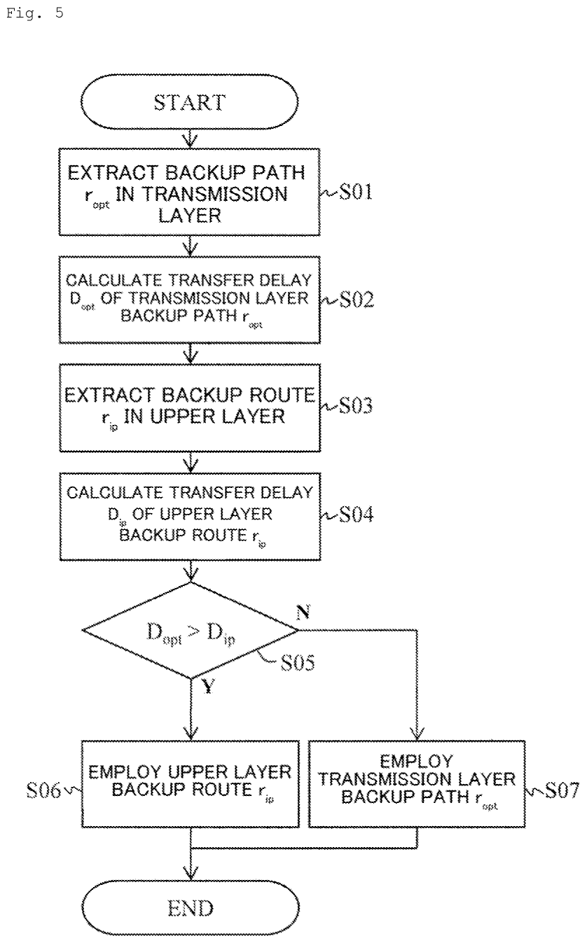

An operation of the preventive maintenance operation selection unit 14 will now be described. FIG. 5 is a view illustrating the operation of the preventive maintenance operation selection unit 14. The preventive maintenance operation selection unit 14 extracts a backup route from each of the layers, calculates a function value realized when each backup route is set, and selects the backup route having the superior function value. Note that in the case described in this embodiment, the function value is the delay.

The preventive maintenance operation selection unit 14 extracts a backup path rₒₚₜ in the transmission layer 51 on the basis of the information I₁₃ indicating the preventive maintenance subject path and the corresponding route through the upper layer network, transmitted thereto from the effect range calculation unit 13 (step S01). For example, when the upper layer 51 is a transmission network with link topology, a reverse path to the preventive maintenance subject path can be set as the backup path rₒₚₜ. Note that extraction of the backup path rₒₚₜ is not limited to this example. The preventive maintenance operation selection unit 14 then calculates a transfer delay Dₒₚₜ in relation to the backup path rₒₚₜ (step S02).

Note that the backup path rₒₚₜ may be constituted by a route, a wavelength, and a transponder that all differ from those of the preventive maintenance subject path. Alternatively, when the preventive maintenance subject extraction unit 12 has been able to specify the cause of the failure in the preventive maintenance subject path, the backup path rₒₚₜ may be formed using the elements of the preventive maintenance subject path, among the route, wavelength, and transponder, that have not failed.

The preventive maintenance operation selection unit 14 may also extract a plurality of backup paths rₒₚₜ.

Meanwhile, the preventive maintenance operation selection unit 14 also extracts a backup route rᵢₚ in the upper layer 52 on the basis of the information 113 indicating the preventive maintenance subject path and the corresponding route through the upper layer network, transmitted thereto from the effect range calculation unit 13 (step S03). For example, when the upper layer 52 is an IP layer, the backup route rᵢₚ can be extracted by calculating a backup route using a Fast Reroute algorithm such as TI-LFA. Note that extraction of the backup path rᵢₚ is not limited to this example. The preventive maintenance operation selection unit 14 then calculates a transfer delay Dᵢₚ in relation to the backup route rᵢₚ (step S04).

The preventive maintenance operation selection unit 14 may also extract a plurality of backup routes rᵢₚ.

Note that steps S03 and S04 may be performed first, followed by steps S01 and S02.

The preventive maintenance operation selection unit 14 compares the transfer delay Dₒₚₜ with the transfer delay Dᵢₚ (step S05). When the transfer delay Dₒₚₜ is larger (“Yes” in step S05), the preventive maintenance operation selection unit 14 selects the backup route rᵢₚ (step S06). In other cases (“No” in step S05), the preventive maintenance operation selection unit 14 selects the backup route rₒₚₜ (step S07).

When pluralities of the backup path rₒₚₜ and the backup route rᵢₚ have been extracted, the preventive maintenance operation selection unit 14 selects the case in which the delay is smallest.

The preventive maintenance operation selection unit 14 then outputs the selected case (the backup path rₒₚₜ or the backup route rᵢₚ) as information I₁₄.

In this embodiment, in a case where a low delay circuit is set, the network delay is set as the selection determination requirement of the preventive maintenance operation selection unit 14, but the selection determination may be performed using a different requirement. For example, the function requirement of the upper layer network may be an SLA (Service Level Agreement), and the switch time to the backup route (a communication interruption time requirement and a delay requirement), the steady-state jitter of each path (a delay requirement), and so on may be used instead of the transfer delay.

The switch time to a backup system is affected by specifications such as the transmission method employed by the upper layer network and the switch used in the transmission devices. Note, however, that if it is possible to store frames in buffers of the respective devices before the route switch is completed, the arrival time appears to be longer to the user, and this affects the delay requirement more than the interruption time requirement.

Further, when the steady-state jitter is set as the function requirement, it is necessary to constantly measure the transfer delay of the NW in order to calculate the jitter value.

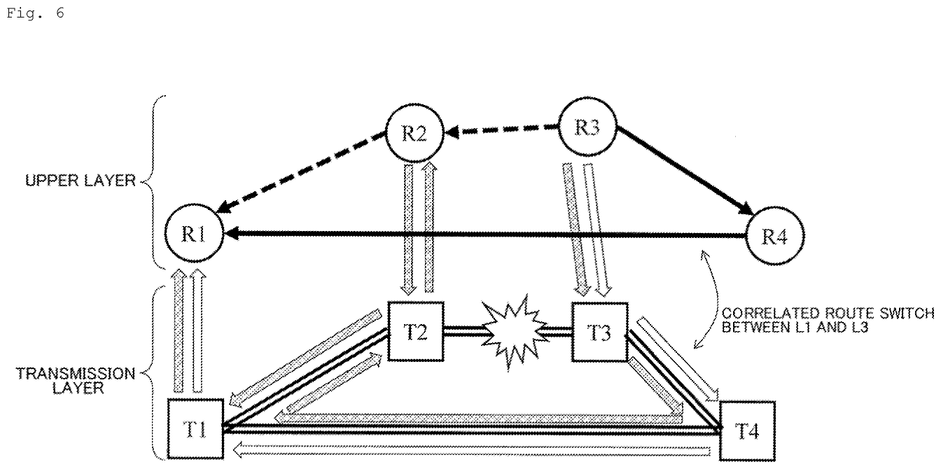

Here, a case in which route switching on the transmission layer 51 does not satisfy the function requirement (a delay requirement) but route switching on the upper layer 52 satisfies the function requirement (a delay requirement) will be described using FIG. 6.

On an upper layer constituted by routers R1-R4 and a transmission layer constituted by optical transmission devices T1-T4, R1, R2, R3, and R4 are accommodated in T1, T2, T3, and T4, respectively. At this time, in order to continue transfer from R3 to R1 in a case where a failure occurs between T2 and T3, since an upper layer backup route of R3-T3-T4-R4-T4-T1-R1 has a shorter transmission distance, or in other words a smaller delay, than a transmission layer backup route of R3-T3-T4-T1-T2-R2-T2-T1-R1, the case in which the backup route is formed in the upper layer is selected.

An operation of the device setting unit 15 will now be described. The device setting unit 15 inputs a setting command I₁₅ₐ into the optical transmission devices 51a of the transmission layer 51 and the devices 52a of the upper layer 52 on the basis of the information I₁₄ indicating the paths through the optical transmission network and the routes through the upper layer network following preventive maintenance, transmitted thereto from the preventive maintenance operation selection unit 14.

Specific examples of inputting a setting command for performing a route switch for the purpose of preventive maintenance into the optical transmission devices 51a and the upper layer network devices 52a will now be described.

Preventive Maintenance on L1 Layer (Transmission Layer)

The device setting unit 15 inputs a setting command for switching to the backup path in relation to the transmission path serving as the preventive maintenance subject.

Preventive Maintenance on L2 Layer (MAC Layer)

The device setting unit 15 inputs a setting command for accommodating a VLAN accommodated in the transmission path serving as the preventive maintenance subject in a different instance.

Preventive Maintenance on L3 Layer (IP Layer)

The device setting unit 15 sets an OSPF command of the route accommodated in the transmission path serving as the preventive maintenance subject at a large value and inputs a setting command ensuring that this route is not selected as the route of the shortest-path.

Alternatively, the device setting unit 15 shuts down a label switching path that passes through the route accommodated in the transmission path serving as the preventive maintenance subject and inputs a setting command so as to employ a different label switching path.

After inputting the setting command I₁₅ₐ, the device setting unit 15 transmits, to the configuration information updating unit 16, information serving as a notification of completion of the switch operation and information I_{15b} indicating the paths and routes through the optical transmission network and the upper layer network following completion of the preventive maintenance operation.

An operation of the configuration information updating unit 16 will now be described. The configuration information updating unit 16 updates the network configuration information in the database 17 by transmitting information I₁₆ indicating the paths through the transmission layer 51 and the routes through the upper layer 52 to the database 17 on the basis of the information I_{15b} from the device setting unit 15.

By means of the configurations described above, the management device 301 performs a route switch for the purpose of preventive maintenance on a network in which respective links of the upper layer 52 constituted by an IP network or the like are housed in the optical transmission network constituting the transmission layer 51 by performing correlated route optimization between the two layers.

The management device 301 is capable of detecting a tendency to failure in a transmission path of the optical transmission network with respect to the network described above and, having satisfied the functional requirements of the upper layer with respect to the route through the upper layer network that is accommodated in the transmission path exhibiting the tendency to failure, implementing a switch to a redundant route without an accompanying communication interruption.

### Second Embodiment

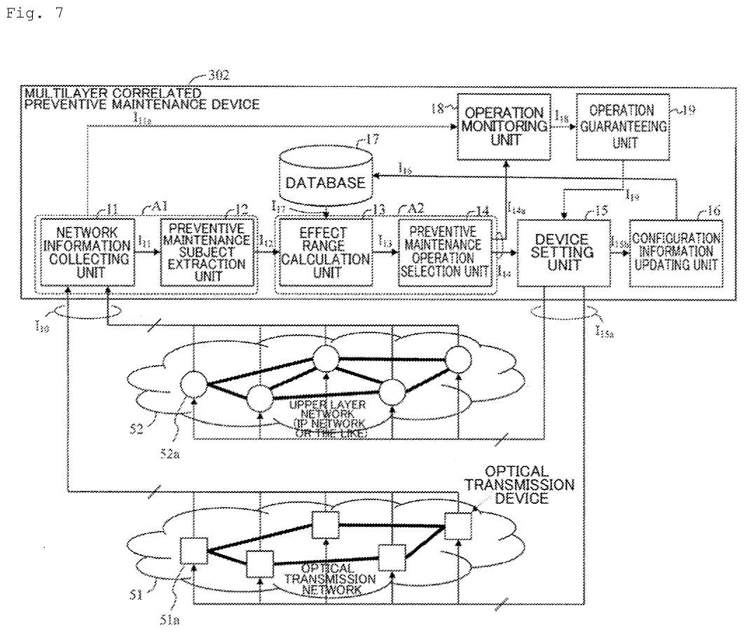

FIG. 7 is a view illustrating a management device 302 according to this embodiment. In this embodiment, only parts that differ from the management device 301 of FIG. 1 will be described.

The management device 302 differs from the management device 301 of FIG. 1 in the following three respects.

Firstly, the network information collecting unit 11 also collects information relating to the routes set in the upper layer 52.

Secondly, an operation monitoring unit 18 that monitors the value of the collected monitoring information lira before and after the device setting unit 15 sets the backup route on the basis of the monitoring information I₁₁ₐ is provided.

Thirdly, an operation guaranteeing unit 19 which, when the value of the monitoring information I₁₁ₐ monitored before and after setting the backup route reaches a predetermined threshold, instructs the device setting unit 15 to return the backup route to the state prior to setting is also provided.

The value of the monitoring information I₁₁ₐ is the information collected by the network information collecting unit 11 and is constituted by a value such as the delay or the Pre-FEC Bit Error Rate, for example.

An operation of the operation monitoring unit 18 will now be described. The operation monitoring unit 18 receives information I₁₄ₐ indicating the paths through the optical transmission network and the routes through the upper layer network following preventive maintenance, transmitted from the preventive maintenance operation selection unit 14, and the monitoring information I₁₁ₐ received from the network information collecting unit 11. On the basis thereof, the operation monitoring unit 18 monitors the network settings from the viewpoint of whether or not the switch operation to the backup path or the backup route has been completed normally.

The operation monitoring unit 18 then classifies the switch monitoring result into the following states and outputs the result as a notification I₁₈.

Normal completion: a determination made in a case where the monitoring information I₁₁ₐ is continuously observed at a value matching the expected operation up to completion of the switch to the backup path or the backup route.

Abnormality: a determination made in a case where the monitoring information I₁₁ₐ takes a value contrary to the expected operation during the switch to the backup path or the backup route.

Abnormal completion: a determination made in a case where the monitoring information I₁₁ₐ takes a value contrary to the expected operation during a switchback operation and after the operation.

An operation of the operation guaranteeing unit 19 will now be described. The operation guaranteeing unit 19 receives the notification I₁₈ corresponding to the state of the network from the operation monitoring unit 18. The operation guaranteeing unit 19 executes the following measures on the basis of the notification I₁₈.

Having received notification of an abnormality, the operation guaranteeing unit 19 outputs a switch operation switchback instruction I₁₉ to the device setting unit 15 to return to the original path or route from the backup path or the backup route.

Having received notification of normal completion or abnormal completion, the operation guaranteeing unit 19 issues a warning to the outside of the management device 302.

An operation of the device setting unit 15 according to this embodiment will now be described. The device setting unit 15 inputs the setting command I₁₅ₐ into the optical transmission devices 51a of the transmission layer 51 and the devices 52a of the upper layer 52 on the basis of the information I₁₄ indicating the paths through the optical transmission network and the routes through the upper layer network following preventive maintenance, transmitted thereto from the preventive maintenance operation selection unit 14, and the switchback instruction I₁₉ transmitted thereto from the operation guaranteeing unit 19.

The device setting unit 15 receives the post-preventive maintenance topology information I₁₄ from the preventive maintenance operation selection unit 14 and inputs a setting command into the optical transmission devices 51a and the upper layer network devices 52a on the basis thereof. The setting command is the same as the setting command described in the first embodiment.

Having received the switchback instruction I₁₉ from the operation guaranteeing unit 19, the device setting unit 15 inputs a setting command to return to the state prior to the backup switch into the optical transmission devices 51a and the upper layer network devices 52a on the basis thereof.

On the basis of the information I₁₄ received from the preventive maintenance operation selection unit 14, the device setting unit 15 issues a request message to collect the monitoring information to the respective devices (51a, 52a).

Finally, after inputting the setting command I₁₅ₐ, the device setting unit 15 transmits information constituting a notification of completion of the switch operation and the information I_{15b} indicating the paths and routes through the optical transmission network and the upper layer network following completion of the preventive maintenance operation to the configuration information updating unit 16.

By means of the configurations described above, in addition to the route switch operation of the management device 301 described in the first embodiment, the management device 302 monitors the communication networks of the transmission layer 51 and the upper layer 52 during a route switch for the purpose of preventive maintenance to determine whether or not the switch operation has been performed normally and, when an abnormality occurs during the switch operation, performs a switchback to the route settings prior to the preventive maintenance route switch.

The management device 302 is capable of implementing the switch to a redundant route performed by the management device 301 described in the first embodiment, and is also capable of returning to the original transfer route when a problem of some type occurs during implementation of the redundant switch.

### Third Embodiment

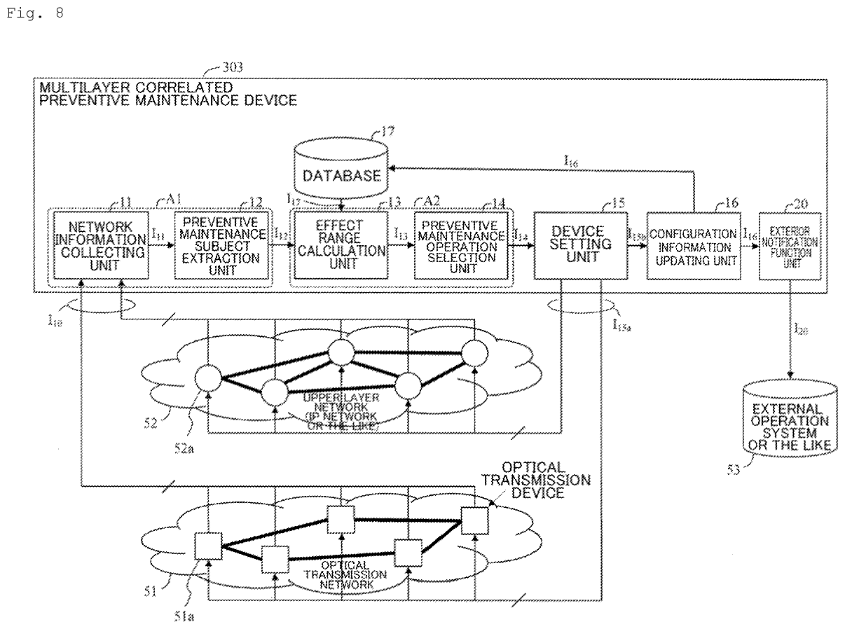

FIG. 8 is a view illustrating a management device 303 according to this embodiment. In this embodiment, only parts that differ from the management device 301 of FIG. 1 will be described.

The management device 303 differs from the management device 301 of FIG. 1 in further including an exterior notification unit 20 that notifies the outside of the topology correspondence information between the transmission layer 51 and the upper layer 52, which has been modified in accordance with the backup route set by the device setting unit 15.

The configuration information updating unit 16 updates the database 17 by transmitting the network configuration information (the information indicating the paths through the optical transmission network and the routes through the upper layer network) I₁₆ following completion of the preventive maintenance operation to the database 17 on the basis of the completion notification I_{15b} from the device setting unit 15. The configuration information updating unit 16 also transmits the information I₁₆ to the exterior notification function unit 20 on the basis of the completion notification I_{15b} from the device setting unit 15.

An operation of the exterior notification unit 20 will now be described. The exterior notification unit 20 notifies an external operation system or the like 53 of network modification content I₂₀ resulting from the multilayer correlated preventive maintenance on the basis of the information I₁₆ transmitted from the configuration information updating unit 16. The purpose of this is to align information indicating the setting implemented on the devices (51a, 52a) by the device setting unit 15 with route information managed by the external operation system 53. A method in which SNMP Trap and REST API are individually defined may be cited as an example of a method of issuing notification of the modification content I₂₀.

By means of the configurations described above, in addition to the route switch operation of the management device 301 described in the first embodiment, the management device 303 notifies the external operation system or the like 53 of the result of the preventive maintenance. The management device 303 is capable of implementing the switch to a redundant route performed by the management device 301 described in the first embodiment, and is also capable of sharing the result of the route modification with the external operation system or the like 53 so that the communication network can be operated while ensuring inter-system consistency between all of the systems relating to the network control.

Note that the exterior notification function unit 20 may be added to the management device 302 of FIG. 7 in order to notify the external operation system or the like 53 of the preventive maintenance result.

[Remarks]

The management device according to the above embodiments is described below.

By using an index for evaluating the signal quality of the transmission layer as a trigger for performing a preventive maintenance switch in the NW of the upper layer and determining, in an integrated fashion, the effects of performing route switches on the respective layers on a functional requirement such as delay, the management device realizes preventive maintenance on an accommodated line through correlation between communication layers in a manner that more closely satisfies the functional requirements of the NW.

More specifically,

(1) A first management device includes the following.
a network information collecting unit that collects monitoring information relating to the respective devices from the optical transmission network and the upper layer network
a preventive maintenance subject extraction unit which, when the index for evaluating the signal quality measured on each transmission path (wavelength path), the index being included in the monitoring information relating to the respective transmission devices collected by the network information collecting unit, corresponds to an index indicating the potential for failure, determines the corresponding path to be the preventive maintenance subject
a network configuration information database that manages, in a database format, information indicating the transmission paths of the transmission layer in which the routes connecting the devices of the upper layer are accommodated and the transmission lines through which these routes pass
an effect range calculation unit that uses the information indicating the transmission paths of the transmission layer in which the routes connecting the devices of the upper layer are accommodated and the transmission lines through which these routes pass, acquired from the network configuration information database, to specify, in relation to the transmission path serving as the preventive maintenance subject transmitted thereto from the preventive maintenance subject extraction unit, the route through the upper layer network in which this path is accommodated
a preventive maintenance operation selection unit that calculates a backup path and a backup route for each of a case in which a backup path is set on the transmission layer and a case in which a backup route is taken on the upper layer on the basis of the information indicating the preventive maintenance subject path and the corresponding route through the upper layer network, transmitted thereto from the effect range calculation unit, and employs the path or route that more closely satisfies the functional requirements of the upper layer network
a device setting unit that inputs a setting command into the devices of the optical transmission network and the upper layer network on the basis of the paths through the optical transmission network and the routes through the upper layer network following preventive maintenance, transmitted thereto from the preventive maintenance operation selection unit, and after performing setting on the respective devices of the optical transmission network and the upper layer network, transmits a completion notification and information indicating the paths/routes through the optical transmission network and the upper layer network following completion of the preventive maintenance operation to the configuration information updating unit
a configuration information updating unit that updates the information indicating the paths through the optical transmission network and the routes through the upper layer network following completion of the preventive maintenance operation in the network configuration information database on the basis of the notification of completion of the switch operation and the information indicating the paths/routes through the optical transmission network and the upper layer network following completion of the preventive maintenance operation, transmitted thereto from the device setting unit

(2) A second management device includes the following in addition to the configurations of the first management device.
a device setting unit that inputs a setting command into the devices of the optical transmission network and the upper layer network on the basis of the paths through the optical transmission network and the routes through the upper layer network following preventive maintenance, transmitted thereto from the preventive maintenance operation selection unit, and a switchback instruction transmitted thereto from an operation guaranteeing unit
an operation monitoring unit that receives the paths through the optical transmission network and the routes through the upper layer network following preventive maintenance, transmitted thereto from the preventive maintenance operation selection unit, and the monitoring information received from the network information collecting unit, monitors the network settings on the basis thereof in order to determine whether or not, during the path/route switch of the preventive maintenance, the switch operation has been completed normally, and performs a classification in relation to a network event found as a result of the monitoring
an operation guaranteeing unit that receives a notification from the operation monitoring unit corresponding to the state of the network as classified by the operation monitoring unit, and on the basis thereof issues a switch operation switchback instruction to the device setting unit and a warning to the exterior of the multilayer correlated preventive maintenance device

(3) A third management device includes the following in addition to the configurations of the first or second management device.
a configuration information updating unit that updates the information indicating the paths through the optical transmission network and the routes through the upper layer network following completion of the preventive maintenance operation in the network configuration information database on the basis of the completion notification from the device setting unit, and transmits the information indicating the paths through the optical transmission network and the routes through the upper layer network following preventive maintenance to the exterior notification function unit
an exterior notification unit that notifies an external operation system or the like of the network modification content realized by the multilayer correlated preventive maintenance device on the basis of the information indicating the paths through the optical transmission network and the routes through the upper layer network following completion of the preventive maintenance operation, acquired from the configuration information updating unit

(Effects)

The present invention enables a reduction in the probability of a signal interruption relating to performance requirements of an NW in an NW service having two or more layers, which requires high availability and low latency. More specifically, in consideration of the tendency of a failure to potentially progress due to aging, temporal variation, and so on, the risk of a potential signal interruption can be avoided by performing preventive maintenance before the failure becomes more apparent.

### REFERENCE SIGNS LIST

11 Network information collecting unit
12 Preventive maintenance subject extraction unit
13 Effect range calculation unit
14 Preventive maintenance operation selection unit
15 Device setting unit
16 Configuration information updating unit
17 Database
18 Operation monitoring unit
19 Operation guaranteeing unit
20 Exterior notification function unit
51 Transmission layer
51a Optical transmission device
52 Upper layer (IP network)
52a Device (router or the like) of upper layer
53 External operation system or the like
301-303 Management device (multilayer correlated preventive maintenance device)

1. A management device for managing a network that includes a transmission layer constituted by an optical transmission network and an upper layer that differs from the transmission layer, the management device comprising:
a database storing topology correspondence information between the transmission layer and the upper layer;
a monitoring unit that monitors routes set in the transmission layer and extracts, from among the routes, a preventive maintenance subject route that satisfies a predetermined requirement;
a selection unit that refers to the topology correspondence information in order to calculate a function of the upper layer in each of a case where a backup route is set in the transmission layer on the basis of a route through the upper layer that corresponds to the preventive maintenance subject route and a case where a backup route is set in the upper layer on the basis of the preventive maintenance subject route, and selects the case in which the calculated function is superior;
a device setting unit that sets the backup route of the case selected by the selection unit in the transmission layer or the upper layer; and
a configuration information updating unit that updates the database on the basis of the backup route set by the device setting unit.

2. The management device according to claim 1, wherein the monitoring unit also monitors routes set in the upper layer,
the management device further comprising:
an operation monitoring unit that monitors a value before and after the device setting unit sets the backup route; and
an operation guaranteeing unit which, when the value monitored by the operation monitoring unit reaches a predetermined threshold, instructs the device setting unit to return the backup route to the state prior to setting.

3. The management device according to claim 1, further comprising an exterior notification unit that notifies the outside of the topology correspondence information between the transmission layer and the upper layer, which has been modified in accordance with the backup route set by the device setting unit.

4. A management method for managing a network that includes a transmission layer constituted by an optical transmission network and an upper layer that differs from the transmission layer, the management method comprising:
extracting, from among routes set in the transmission layer, a preventive maintenance subject route that satisfies a predetermined requirement;
referring to topology correspondence information between the transmission layer and the upper layer, the information being stored in a database, in order to calculate a function of the upper layer in each of a case where a backup route is set in the transmission layer on the basis of a route through the upper layer that corresponds to the preventive maintenance subject route and a case where a backup route is set in the upper layer on the basis of the preventive maintenance subject route;
selecting the case in which the calculated function is superior;
setting the backup route of the selected case in the transmission layer or the upper layer; and
updating the database on the basis of the set backup route.

5. The management method according to claim 4, further comprising:
monitoring routes set in the upper layer; and
when a value monitored before and after setting of the backup route reaches a predetermined threshold, issuing an instruction to return the backup route to the state prior to setting.

6. The management method according to claim 4, further comprising notifying the outside of the topology correspondence information between the transmission layer and the upper layer, which has been modified in accordance with the set backup route.
